(19) United States
(12) Patent Application Publication
(10) Pub. No.: US 2025/0093094 A1
(43) Pub. Date: Mar. 20, 2025

(54) WASTE HEAT RECOVERY IN CRUDE PROCESSING FOR INCREASING HYDROCARBON YIELD AND REDUCING EMISSIONS

(71) Applicant: Saudi Arabian Oil Company, Dhahran (SA)

(72) Inventors: Srinivasaiah Kamandahalli, Dhahran (SA); Kamarul Ariffin Amminudin, Dhahran (SA)

(21) Appl. No.: 18/469,041

(22) Filed: Sep. 18, 2023

(51) Int. Cl. F25J 3/02

(52) U.S. Cl. CPC F25J 3/0233; F25J 3/0209; F25J 2240/02; F25J 2270/12

(57) ABSTRACT

Low grade waste heat is captured in a gas-oil separation plant (GOSP). Heat is transferred from a first hydrocarbon gas stream to a first portion of a mixed refrigerant stream to vaporize the first portion. Heat is transferred from a first portion of a mixture of the first hydrocarbon gas stream and a second hydrocarbon gas stream to a second portion of the mixed refrigerant stream to vaporize the second portion. Heat is transferred from a second portion of the mixture to a third portion of the mixed refrigerant stream to vaporize the third portion. A combined stream, including the vaporized first, second, and third portions, is flowed through a turbine-generator. Flowing the combined stream through the turbine-generator causes a rotor of the turbine-generator to rotate. Electrical power is generated in response to rotation of the rotor. The combined stream is condensed to reform the mixed refrigerant stream.

### TECHNICAL FIELD

This disclosure relates to waste heat recovery in gas-oil separation plants.

### BACKGROUND

Natural gas and crude oil can be found in hydrocarbon-bearing reservoirs. In many cases, gas-oil separation plants (GOSPs) are employed to process raw natural gas and/or raw crude oil received from a wellhead. GOSPs can purify raw natural gas and/or raw crude oil by removing common contaminants, such as water, carbon dioxide, and hydrogen sulfide. GOSPs can include a train of vessels that operate at sequentially lower pressure to remove volatile gases, water, and salt from raw crude oil. Some of the substances which contaminate natural gas have economic value and can be further processed, sold, or both. GOSPs often release large amounts of waste heat into the environment.

### SUMMARY

This disclosure describes technologies relating to low grade waste heat recovery in gas-oil separation plants to simultaneously generate power and decrease power usage.

Certain aspects of the subject matter described can be implemented as a method for capturing low grade waste heat in a gas-oil separation plant (GOSP). Heat is transferred from a first hydrocarbon gas stream to a first portion of a mixed refrigerant stream to vaporize the first portion of the mixed refrigerant stream. The first hydrocarbon gas stream is separated from a crude oil stream by a first separator positioned in the GOSP. Heat is transferred from a first portion of a mixture of the first hydrocarbon gas stream and a second hydrocarbon gas stream to a second portion of the mixed refrigerant stream to vaporize the second portion of the mixed refrigerant stream. The second hydrocarbon gas stream is separated from the crude oil stream by a second separator positioned in the GOSP. Heat is transferred from a second portion of the mixture to a third portion of the mixed refrigerant stream to vaporize the third portion of the mixed refrigerant stream. A combined stream is flowed through a turbine-generator. The combined stream includes the vaporized first, second, and third portions of the mixed refrigerant stream. Flowing the combined stream through the turbine-generator causes a rotor of the turbine-generator to rotate. Electrical power is generated in response to rotation of the rotor of the turbine-generator. The combined stream from the turbine-generator is cooled to condense the combined stream to reform the mixed refrigerant stream in a liquid state.

This, and other aspects, can include one or more of the following features. In some implementations, cooling the combined stream includes flowing the combined stream through a first side of a first heat exchanger. In some implementations, cooling the combined stream includes flowing the combined stream from the first side of the first heat exchanger through a second heat exchanger. In some implementations, cooling the combined stream includes flowing the combined stream from the second heat exchanger through a second side of the first heat exchanger. The combined stream flowing through the first side of the first heat exchanger can transfer heat to the combined stream flowing through the second side of the first heat exchanger. In some implementations, after transferring heat from the first hydrocarbon gas stream to the first portion of the mixed refrigerant stream, phases of the mixture are separated to produce a first aqueous liquid phase and the first portion of the mixture. The first portion of the mixture can be in a vapor state prior to transferring heat from the first portion of the mixture to the second portion of the mixed refrigerant stream. In some implementations, transferring heat from the first portion of the mixture to the second portion of the mixed refrigerant stream facilitates at least partial condensation of the first portion of the mixture. In some implementations, after transferring heat from the first portion of the mixture to the second portion of the mixed refrigerant stream, phases of the first portion of the mixture are separated to produce a second aqueous liquid phase, a first non-aqueous liquid phase, and the second portion of the mixture. The second portion of the mixture can be in a vapor state prior to transferring heat from the second portion of the mixture to the third portion of the mixed refrigerant stream. In some implementations, transferring heat from the second portion of the mixture to the third portion of the mixed refrigerant stream facilitates at least partial condensation of the second portion of the mixture. In some implementations, after transferring heat from the second portion of the mixture to the third portion of the mixed refrigerant stream, phases of the second portion of the mixture are separated to produce a third aqueous liquid phase, a second non-aqueous liquid phase, and a fourth portion of the mixture. In some implementations, the first non-aqueous liquid phase and the second non-aqueous liquid phase are fractionated to produce an overhead vapor stream as distillate and a natural gas liquids (NGL) stream as bottoms. A rate at which the NGL stream is produced by the GOSP can be increased by at least 5% when compared to a control GOSP that does not capture low grade waste heat from the first hydrocarbon stream, the first portion of the mixture, and the second portion of the mixture.

Certain aspects of the subject matter described can be implemented as a low grade waste heat capture system. The system includes a first hydrocarbon gas stream, a second hydrocarbon gas stream, and a refrigeration loop. The first hydrocarbon gas stream is separated from a crude oil stream by a first separator positioned in a GOSP. The second hydrocarbon gas stream is separated from the crude oil stream by a second separator positioned in the GOSP. The refrigeration loop includes a mixed refrigerant stream, a first waste heat recovery heat exchanger, a second waste heat recovery heat exchanger, a third waste heat recovery heat exchanger, a turbine-generator, and a condenser. The mixed refrigerant stream is in a liquid state. The first waste heat recovery heat exchanger is configured to transfer heat from the first hydrocarbon gas stream to a first portion of the mixed refrigerant stream to vaporize the first portion of the mixed refrigerant stream. The second waste heat recovery heat exchanger is configured to transfer heat from a first portion of a mixture of the first hydrocarbon gas stream and the second hydrocarbon gas stream to a second portion of the mixed refrigerant stream to vaporize the second portion of the mixed refrigerant stream. The third waste heat recovery heat exchanger is configured to transfer heat from a second portion of the mixture to a third portion of the mixed refrigerant stream to vaporize the third portion of the mixed refrigerant stream. The turbine-generator is configured to receive a combined stream comprising the vaporized first, second, and third portions of the mixed refrigerant stream. The turbine-generator includes turbine blades coupled to a rotor. The turbine blades are configured to rotate in response to flow of the combined stream through the turbine-generator. The rotor is configured to rotate with the turbine blades. The turbine-generator is configured to generate electrical power in response to rotation of the rotor. The condenser is configured to cool the combined stream from the turbine-generator to condense the combined stream to reform the mixed refrigerant stream in the liquid state.

This, and other aspects, can include one or more of the following features. In some implementations, the condenser is a first condenser including a first side and a second side. In some implementations, the first side of the first condenser is configured to receive the combined stream from the turbine-generator. In some implementations, the system includes a second condenser configured to receive and cool the combined stream from the first side of the first condenser. In some implementations, the second side of the first condenser is configured to receive the combined stream from the second condenser. The first condenser can be configured to transfer heat from the combined stream at the first side to the combined stream at the second side. In some implementations, the system includes a third separator configured to receive and separate phases of the mixture to produce a first aqueous liquid phase and the first portion of the mixture. The first portion of the mixture can be in a vapor state prior to entering the second waste heat recovery heat exchanger. In some implementations, transferring heat from the first portion of the mixture to the second portion of the mixed refrigerant stream by the second waste heat recovery heat exchanger facilitates at least partial condensation of the first portion of the mixture. The system can include a fourth separator configured to receive the first portion of the mixture from the second waste heat recovery heat exchanger. The fourth separator can be configured to separate phases of the first portion of the mixture to produce a second aqueous liquid phase, a first non-aqueous liquid phase, and the second portion of the mixture. The second portion of the mixture can be in a vapor state prior to entering the third waste heat recovery heat exchanger. In some implementations, transferring heat from the second portion of the mixture to the third portion of the mixed refrigerant stream by the third waste heat recovery heat exchanger facilitates at least partial condensation of the second portion of the mixture. The system can include a fifth separator configured to receive the second portion of the mixture from the third waste heat recovery heat exchanger. The fifth separator can be configured to separate phases of the second portion of the mixture to produce a third aqueous liquid phase, a second non-aqueous liquid phase, and a fourth portion of the mixture. In some implementations, the system includes a distillation column configured to receive and fractionate the first non-aqueous liquid phase and the second non-aqueous phase to produce an overhead vapor stream as distillate and a natural gas liquids (NGL) stream as bottoms. A rate at which the NGL stream is produced by the GOSP can be increased by at least 5% when compared to a control GOSP that does not capture low grade waste heat from the first hydrocarbon stream, the first portion of the mixture, and the second portion of the mixture via the first waste heat recovery heat exchanger, the second waste heat recovery heat exchanger, and the third waste heat recovery heat exchanger, respectively.

Certain aspects of the subject matter described can be implemented as a method. A first hydrocarbon gas stream is flowed to a first waste heat recovery heat exchanger, wherein the first hydrocarbon gas stream is separated from a crude oil stream by a first separator positioned in a GOSP. The first waste heat recovery heat exchanger transfers heat from the first hydrocarbon gas stream to a first portion of a mixed refrigerant stream to vaporize the first portion of the mixed refrigerant stream. A first portion of a mixture of the first hydrocarbon stream and a second hydrocarbon gas stream is flowed to a second waste heat recovery heat exchanger. The second hydrocarbon gas stream is separated from the crude oil stream by a second separator positioned in the GOSP. The second waste heat recovery heat exchanger transfers heat from the first portion of the mixture to a second portion of the mixed refrigerant stream to vaporize the second portion of the mixed refrigerant stream. A second portion of the mixture is flowed to a third waste heat recovery heat exchanger. The third waste heat recovery heat exchanger transfers heat from the second portion of the mixture to a third portion of the mixed refrigerant stream to vaporize the third portion of the mixed refrigerant stream. A combined stream is flowed through a turbine-generator. The combined stream includes the vaporized first, second, and third portions of the mixed refrigerant stream. Flowing the combined stream through the turbine-generator causes a rotor of the turbine-generator to rotate. Electrical power is generated in response to rotation of the rotor of the turbine-generator. The combined stream from the turbine-generator is condensed to reform the mixed refrigerant stream in a liquid state.

This, and other aspects, can include one or more of the following features. In some implementations, condensing the combined stream includes flowing the combined stream through a first side of a first heat exchanger. In some implementations, condensing the combined stream includes flowing the combined stream from the first side of the first heat exchanger through a second heat exchanger. In some implementations, condensing the combined stream includes flowing the combined stream from the second heat exchanger through a second side of the first heat exchanger, wherein the combined stream flowing through the first side of the first heat exchanger transfers heat to the combined stream flowing through the second side of the first heat exchanger. In some implementations, after transferring heat from the first hydrocarbon gas stream to the first portion of the mixed refrigerant stream, phases of the mixture are separated to produce a first aqueous liquid phase and the first portion of the mixture. The first portion of the mixture can be in a vapor state prior to transferring heat from the first portion of the mixture to the second portion of the mixed refrigerant stream. In some implementations, transferring heat from the first portion of the mixture to the second portion of the mixed refrigerant stream facilitates at least partial condensation of the first portion of the mixture. The method can include, after transferring heat from the first portion of the mixture to the second portion of the mixed refrigerant stream, separating phases of the first portion of the mixture to produce a second aqueous liquid phase, a first non-aqueous liquid phase, and the second portion of the mixture. The second portion of the mixture can be in a vapor state prior to transferring heat from the second portion of the mixture to the third portion of the mixed refrigerant stream. In some implementations, transferring heat from the second portion of the mixture to the third portion of the mixed refrigerant stream facilitates at least partial condensation of the second portion of the mixture. The method can include, after transferring heat from the second portion of the mixture to the third portion of the mixed refrigerant stream, separating phases of the second portion of the mixture to produce a third aqueous liquid phase, a second non-aqueous liquid phase, and a fourth portion of the mixture. In some implementations, the first non-aqueous liquid phase and the second non-aqueous liquid phase are fractionated to produce an overhead vapor stream as distillate and a natural gas liquids (NGL) stream as bottoms. A rate at which the NGL stream is produced by the GOSP can be increased by at least 5% when compared to a control GOSP that does not capture low grade waste heat from the first hydrocarbon stream, the first portion of the mixture, and the second portion of the mixture.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an example gas-oil separation plant (GOSP) including a low grade waste heat capture system.

FIG. 2 is a flow chart of an example method for capturing low grade waste heat in a GOSP.

FIG. 3 is a flow chart of an example method for capturing low grade waste heat in a GOSP.

### DETAILED DESCRIPTION

This disclosure describes utilizing low grade waste heat in gas-oil separation plants (GOSPs) to simultaneously generate power and decrease power usage within the GOSP. The power generated from the low grade waste heat can be used within the GOSP, be provided to a local power grid, or both. The low grade waste heat is sourced from the exhaust of various compressors within the GOSP for pressurizing the gas separated from crude oil. The low grade waste heat is recovered through various heat exchangers connected to an organic Rankine cycle (ORC). The ORC uses the low grade waste heat to evaporate a working fluid, which in turn drives rotation of a turbine-generator, thereby generating power. The system not only generates power and reduces power usage within the GOSP, but also cools the gas separated from the crude oil to a cooler temperature in comparison to conventional fin-fan air coolers, which facilitates condensation of hydrocarbons and in turn, production of valuable condensate by the GOSP. By reducing the power requirement of the GOSP, greenhouse gas emissions by the GOSP are reduced as well.

The subject matter described in this disclosure can be implemented in particular implementations, so as to realize one or more of the following advantages. Low grade waste heat generated by GOSPs can be recovered and utilized to generate electrical power. The generated electrical power can be used within the GOSP, provided to another unit (such as a gas sweetening unit or a natural gas liquids fractionating unit), provided to an end user, provided to a power grid, or any combinations of these. By recovering low grade waste heat from the GOSP, refrigeration loads required by the GOSP in processing crude oil and natural gas can be reduced, which can help to save on operating costs. Recovering low grade waste heat from the GOSP can reduce the power consumption used by various compressors of the GOSP, which reduces operating costs. Recovering low grade waste heat from the GOSP reduces the operating temperatures of various gas streams flowing in the GOSP, which causes a larger portion of such gas streams to condense and produce condensate, which is another valuable product. Further, the reduced operating temperatures of various gas streams flowing in the GOSP can cause additional water to condense, thereby facilitating separation of free water from the crude. The water (which typically includes contaminants such as salt) can cause corrosion in pipelines, so removal of this water can reduce and/or eliminate the risk of pipeline corrosion. Recovering low grade waste heat from the GOSP can also eliminate the use of fin-fan air coolers at the outlets of the compressors of the GOSP, which can result in significant savings on both capital and operating costs. By reducing power consumption and also generating power, the described systems and methods can also decrease the carbon footprint of the GOSP.

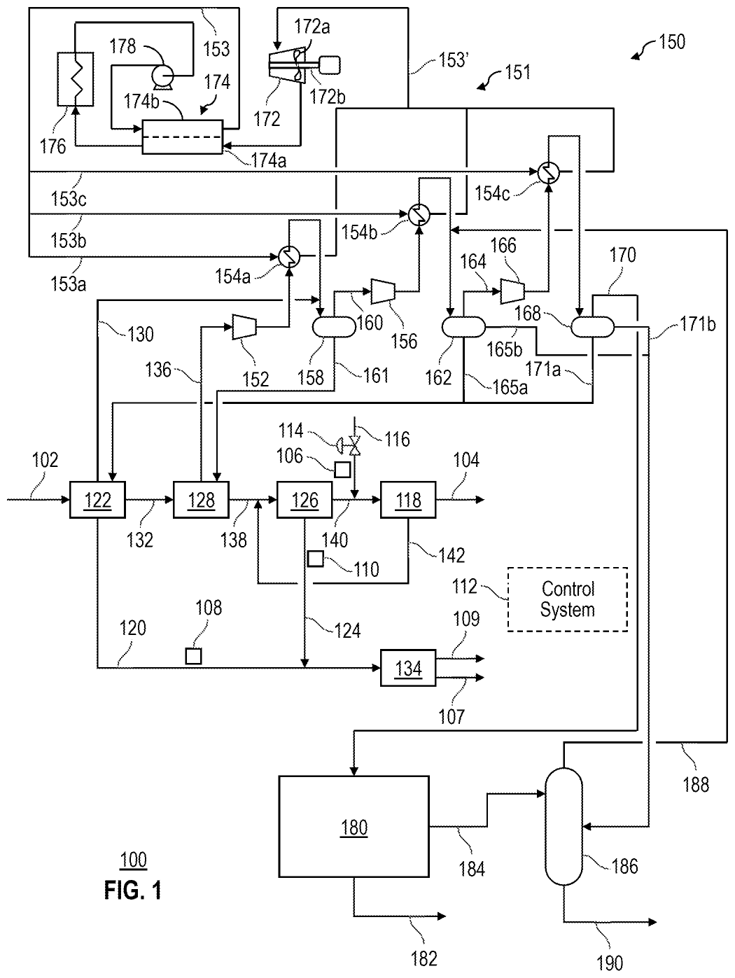

FIG. 1 is a schematic diagram of an example gas-oil separation plant (GOSP) 100 including a low grade waste heat capture system 150. The GOSP 100 processes crude oil 102 received from a wellhead and discharges export crude oil 104 as product. The crude oil 102 can include natural gas. As discussed below, the GOSP 100 removes salt from the crude oil 102. The salt is dissolved in the fine water droplets in the crude oil 102 and generally not in the crude oil 102 itself. The salt content can include chloride and bromide salts. For example, the salt content can include sodium chloride (NaCl), calcium chloride (CaCl₂)), magnesium chloride (MgCl₂), potassium chloride (KCl), and other inorganic salts. The GOSP 100 includes multiple analyzer instruments (e.g., 106, 108, 110, etc.) to measure salt concentration of streams internal in the GOSP 100 such that the salt concentration in the export crude 104 can be calculated. The analyzer instruments can measure sodium to give the salt concentration as based on sodium chloride (NaCl). The control system 112 (or computer system) can perform a mass balance to determine (calculate) salt content in the export crude oil 104 based on the measurements by the analyzer instruments. In view of the measurements by the analyzer instruments, the control system 112 can direct the flowrate set point of the flow control valve 114 (or wash-water pump) that controls the flowrate of the wash water 116 supplied to the desalter 118 vessel.

The multiple analyzer instruments (e.g., 106, 108, 110, etc.) can each be an online analyzer instrument (analyzer tool) to measure concentration of salt (e.g., NaCl) in water in a stream. The online analyzer instrument can be disposed along a conduit conveying the stream. The illustrated embodiment includes at least three such online analyzer instruments that measure salt concentration: (1) online analyzer instrument 106 that measures salt concentration in the wash water 116; (2) online analyzer instrument 108 that measures salt concentration in the water 120 that discharges from the high-pressure production trap (HPPT) 122; and (3) online analyzer instrument 110 that measures salt concentration in the water of the oily water 124 that discharges from the dehydrator 126 vessel. The analytical techniques, mass balances, and control schemes are discussed below with respect to subsequent figures.

The feed crude oil 102 received at the GOSP 100 from a well can be as produced from a subterranean formation through a wellbore (and production manifold) to the GOSP 100. The feed crude oil 102 can flow through a production manifold associated with one or more wellheads to the GOSP 100. The feed crude oil 102 can be from a well pool. The feed crude oil 102 can include water and thus be labeled as wet crude oil. The feed crude oil 102 received at the GOSP 100 can be a tight emulsion of oil and water in some examples. A tight emulsion is generally an emulsion with small and closely distributed droplets. The GOSP 100 removes gas, water, and salt from the crude oil 102. The GOSP 100 can remove hydrocarbons as gas from the crude oil via lowering pressure of the crude oil 102. The removed hydrocarbons can be light hydrocarbons (e.g., C1 to C4) and medium or heavier hydrocarbons (e.g., C5+).

In the illustrated implementation, the GOSP 100 includes the HPPT 122, a low-pressure production trap (LPPT) 128, the dehydrator 126, and the desalter 118. The HPPT 122, LPPT 128, dehydrator 126, and desalter 118 can be characterized as components of a GOSP 100 train. The HPPT 122, LPPT 128, dehydrator 126, and desalter 118 are each a separator vessel that can have a horizontal orientation or vertical orientation. In embodiments, the HPPT 122, LPPT 128, dehydrator 126, and desalter 118 are all horizontal vessels. In certain examples, the HPPT 122 vessel, LPPT 128 vessel, dehydrator 126 vessel, and desalter 118 vessel each have semi-elliptical-type heads, hemispherical heads, or torispherical heads.

The HPPT 122 vessel, LPPT 128 vessel, dehydrator 126 vessel, and desalter 118 vessel generally include nozzles (e.g., flanged, screwed connections, etc.) on the vessel body or heads to couple to conduits for receiving and discharging streams. An inlet on the vessel can be a nozzle that couples to (for example, connects to or attaches to) a feed or supply conduit to the vessel. An outlet on the vessel can be a nozzle (or multiple nozzles) that couples to a discharge conduit from the vessel. Nozzles on the vessels can also be employed for instrumentation (e.g., sensors, gauges, transmitters, etc.) and other uses.

In operation, the HPPT 122 can receive the feed crude oil 102 via a conduit. The HPPT 122 as a separation vessel can provide for a three-phase separation. In particular, the HPPT 122 separates gas 130 and water 120 from the feed crude oil 102 and discharges crude oil 132. This HPPT water 120 discharge stream is generally not oily due to the fact that there is typically a constant water level in the HPPT 122, which keeps the oil droplets at the interface, not in the bulk. The HPPT 122 vessel can include an inlet separation device to promote separation of the gas 130 from the feed crude oil 102. The inlet separation device can promote an initial gross separation by changing the flow direction of the feed crude oil 102 entering the HPPT 122 vessel. The inlet separation device can be, for example, an inlet diverter, a vane-type inlet device, or a cyclonic inlet device.

The HPPT 122 as a three-phase separator vessel can utilize gravity or density difference to separate the water 120 from the crude oil 132. For instance, the HPPT 122 vessel can include a weir to facilitate the separation in which the oil (the lighter of the two liquids) overflows the weir. The water 120 can generally discharge from within the weir. The separated water 120 can be sent, for example, to a water/oil separator (WOSEP) 134 vessel. The WOSEP 134 can discharge a water stream 107 and a recovered oil stream 109. In implementations, the operating pressure in the HPPT 122 can be at least 50 pounds per square inch gauge (psig). The operating temperature in the HPPT 122 can be, for example, at least about 65° F., or in a range of 65° F. to 160° F.

The separated gas 130 that discharges from the HPPT 122 can generally be light hydrocarbons. The feed crude oil 102 is reduced in pressure in the HPPT 122 to separate the gas 130. In embodiments, the gas 130 can be light hydrocarbons (C1-C4) having a number of carbons in the range 1 to 4 and trace amount of C5+ hydrocarbons having five or more carbons. In examples, the gas 130 as a light (or lighter) hydrocarbon stream can generally be C1-C4 components (e.g., methane, ethane, propane, butane, isobutane) and trace amounts of C5+ compounds. The pressure of the gas 130 as discharged can range in pressure, for example, from 50 psig to 450 psig depending, for instance, on the supply pressure of the feed crude oil 102. The gas 130 can include lighter hydrocarbons, traces of C5+ hydrocarbons, hydrogen sulfide (H₂S), carbon dioxide (CO₂), nitrogen (N₂), and water vapor. The relative amounts and types of compounds in the gas 130 can typically depend on composition of the feed crude oil 102 and the flash pressure in the HPPT 122. The separated gas 130 can be sent to a mechanical compressor, such as a 1^{st} stage high pressure (HP) compressor 156.

The crude oil 132 is discharged from the HPPT 122 via a conduit to the LPPT 128. The motive force for flow of the crude oil 132 can be pressure differential. The LPPT 128 operates at a lower pressure than the HPPT 122. In implementations, the operating pressure in the LPPT 128 can be equal to or less than 3 psig. The operating temperature of the LPPT 128 can be, for example, at least about 65° F., or in a range of 65° F. to 160° F. The LPPT 128 vessel can include an inlet device to promote an initial gross separation of gas 136 from the crude oil 132 by changing the flow direction of the entering crude oil 132.

The LPPT 128 can be characterized as a two-phase separation vessel or three-phase separation vessel. The LPPT 128 separates gas 136 (e.g., certain remaining off-gases) from the crude oil 132 and discharges a crude oil 138 stream. The gas 136 can typically be heavier hydrocarbons. The medium or heavy hydrocarbon stream as the gas 136 can refer generally to C5+ (five-carbon and greater) hydrocarbons (e.g., pentane, isopentane, hexane, and heptane) and trace amounts of lighter hydrocarbons and other light components. In certain examples, the gas 136 can discharge at a pressure of, at least 1 psig, or in a range of 1 psig to 90 psig. The gas 136 can be sent to a mechanical compressor, such as a low pressure (LP) compressor 152.

The crude oil 138 discharged from the LPPT 128 can be sent to the dehydrator 126. In implementations, the crude oil can be pumped from the LPPT 128 to the dehydrator 126 via a pump (not shown). The pump can be, for example, a centrifugal pump. In certain implementations, the crude oil 138 can flow through a heat exchanger (not shown) to heat the crude oil 138. The heat exchanger can be, for example, a shell-and-tube heat exchanger, a plate-and-frame heat exchanger, etc. In operation, the pump head provides motive force for flow of the crude oil 138 through the heat exchanger to the dehydrator 126. The heat exchanger heats the crude oil 138 to advance downstream separation of water and salt from the crude oil. This increase in temperature of the crude oil 138 can reduce fluid viscosity and can promote settling of water droplets from the crude oil in downstream processing. The heat transfer fluid for the heat exchanger can be, for example, steam or steam condensate, or a process stream (e.g., crude oil from a stabilizer column (not shown)). The crude oil 138 can be heated in the heat exchanger via cross-exchange with other crude oil to recover heat from the other crude oil. In some embodiments, a low-pressure degassing tank (LPDT) (not shown) can replace the LPPT 128 and can be operationally disposed between the HPPT 122 and the dehydrator 126.

In the dehydrator 126 vessel, water 124 is separated from the crude oil 138. Salt can discharge with the water 124 and thus be removed from the crude oil 140. Electrostatic coalescence can be employed in the dehydrator 126. In implementations, an electrostatic field is generated between electrodes in the dehydrator 126 vessel. Electrostatic coalescence applies an electric current, causing water droplets in the crude oil (emulsion) to collide, coalesce into larger (heavier) drops, and settle out of the crude oil as separate liquid water. This process partially dries wet crude oil. In one example, operating conditions of a dehydrator 126 unit include temperature in a range of 70° F. to 160° F., and a pressure at about 25 psig above the crude oil 140 vapor pressure. In some examples, fresh or recycle wash water (e.g., relatively low in salt) and/or chemicals can be injected into the dehydrator 126 vessel to advance separation of the water 124 from the crude oil 138. The separated water 124 discharged from the dehydrator 126 can be oily water (e.g., having salt) and sent to the WOSEP 134 vessel. In examples, oily water can have less than 10 volume percent (vol. %) or less than 1 vol. % oil. The dehydrator 126 vessel can discharge crude oil 140 via a conduit to the desalter 118 vessel. The crude oil 140 can be labeled as dehydrated crude oil with some salt removed in implementations.

The salt removal in the GOSP 100 can be multi-stage. Both the desalter 118 and the dehydrator 126 can provide for salt removal. Thus, the embodiment of FIG. 1 can be two-stage desalting (salt removal). Moreover, in some examples, the desalter 118 can be two or more desalter vessels in series. In the illustrated example, a single desalter 118 vessel is depicted. Water 142 having salt discharges from the desalter 118 and can be recycled to the dehydrator 126. Wash water 116 (e.g., fresh water) can be added to the desalter 118 vessel to facilitate removal of salt from the crude oil 140. Wash water 116 can be supplied to the desalter 118 to promote the separation generated by the electrostatic field in the desalter 118 vessel. The wash water 116 can be injected into the dehydrated crude oil 140 entering the desalter 118 to wash the crude oil to meet the salt content specification of the produced crude (export crude oil 104). The water 116 added can be low in salt concentration relative to the salt concentration of water (e.g., emulsified water) in the crude oil 140. Fresh wash water (as opposed, for example, to recycle water having more salt) can be utilized in the desalting process to increase the amount of salt rinsed from the crude oil 140. Wash water 116 salinity (total dissolved solids, TDS) can range, for example, from between about 100 parts per million (ppm) to about 12,000 ppm. Again, wash water 116 can be more effective if the salinity (TDS) level is low. In comparison, formation water salinity produced with crude oil can reach as high as about 400,000 ppm of salt or more.

The flowrate of the wash water 116 can be controlled via the flow control valve 114 as depicted. The valve opening (e.g., percent open) of the flow control valve can be adjusted by a flow controller (FC) to maintain flowrate of the wash water 116 per a flowrate set point of the flow controller for the control valve 114. The set point for the control valve 114 can be manually set locally or manually entered into the control system 112. On the other hand, the specifying of the flowrate of the wash water 116 can be automated. In particular, the set point for the control valve 114 can be specified by the control system 112 based on feedback from online analyzer instruments and meters in the GOSP 100. For example, the control system 112 can determine and specify the set point for the control valve 114 based in part on feedback from the online analyzer instruments 106, 108, 110.

In addition to (or in lieu of) the control valve 114, flowrate of the wash water 116 can be controlled via the speed of the pump supplying the wash water 116. The pump can be, for example, a positive displacement pump or a centrifugal pump. The speed of the pump can be manually set. In embodiments, the control valve 114 can determine and specify the speed of the pump to give the desired flowrate of wash water 116. The desired flow rate can be control-system 112 specified based at least (based in part) on measurements by the analyzer instruments 106, 108, 110. To give the desired flowrate of wash water 116, the speed of the pump can be set, for example, by adjusting the pump stroke (e.g., the number of strokes per time, the number of stroke cycles per time, the length of a stroke, etc.). In some implementations, the adjustment of the pump stroke can be manual (local) or remotely adjusted by the control system 112 to give the flowrate wash water 116 specified by the control system 112.

As in the upstream dehydrator 126, electrostatic coalescence can be employed in the desalter 118 vessel. Electrostatic coalescence can remove water from the crude oil 140. Operating conditions in the desalter 118 can be, for example, include a temperature in a range of 70° F. to 160° F. and an operating pressure at least 25 psig above vapor pressure of the crude oil 140. The wash water 116 can increase the water droplet number concentration to promote coalescence to form larger and more easily separated water droplets to meet the crude salt content specification. Both the flowrate and quality (salinity) of wash water 116 can affect the crude desalting process. The desalter 118 can reduce the salt content of crude oil 140, for example, to less than 10 pounds of salt per thousand barrels (PTB) of oil.

The crude oil that discharges from the desalter 118 can be the export crude oil 104. The desalter 118 can discharge the export crude oil 104 for distribution including to storage and transportation, and for further processing such as in a petroleum refinery. The export crude oil 104 can be labeled as processed crude oil, product crude oil, stabilized crude oil, and so forth. The salt content of the export crude oil 104 can be monitored manually by periodically determining the salt content through laboratory analysis (e.g., once per 8-hour shift). The salt content of the export crude oil 104 can be continuously monitored with an automated online analyzer. The output from the online analyzer can be used, in part, to control the wash water flow rate to the desalter 118. The salt content of the export crude oil 104 can be monitored by determining the salt content based on calculating a salt mass balance (e.g., in real time) in the GOSP 100 utilizing online data for streams in the GOSP 100.

Specifications for the export crude oil 104 can include, for example: (1) salt content less than 10 PTB; (2) basic sediment and water (BS&W) content less than 0.2 volume percent (vol %) of the crude oil; (3) hydrogen sulfide (H₂S) content less than 70 ppm by weight (ppmw); and (4) maximum true vapor pressure (TVP) (per ASTM D 2879) less than 13 pounds per square inch absolute (psia) at storage temperature. The BS&W is generally measured from a liquid sample of the crude oil. The BS&W includes water, sediment, and emulsion. The BS&W is typically measured as a volume percentage of the crude oil. The BS&W specification can be less than 0.5 vol % for Heavy crude oil and less than 0.2 vol % for other crude oils.

In some examples, the desalter 118 can discharge the export crude oil 104 via a conduit to a stabilizer distillation column (not shown) that separates and removes light ends or light components (volatile components such as C1-C4 hydrocarbons) as gas from the export crude oil 104. These light components can discharge as an overhead stream from the stabilizer distillation column. This removal of the light components reduces vapor pressure of the export crude oil 104 to give a desired vapor pressure of the export crude oil 104 as stabilized crude oil. The associated specification of the export crude oil 104 can be, for example, Reid vapor pressure (RVP) or true vapor pressure (TVP), or both. The term “stabilized” can refer to the crude oil having a lower vapor pressure and thus being less volatile to facilitate tank storage and pipeline transport. The stabilization can be, for example, to lower the vapor pressure of the crude oil to at least 13 pounds per square inch (psi) below atmospheric pressure so that vapor will generally not flash under atmospheric conditions. The stabilizer distillation column can remove H₂S from the export crude oil 104 to sweeten the crude oil. The H₂S can discharge in the overhead stream in the light components. The terms “sweet” crude oil or to “sweeten” crude oil refers to lower H₂S content in the crude oil. In the stabilizer distillation column, any H₂S gas dissolved in the export crude oil 104 is removed to meet crude-oil specification of H₂S content, for example, less than 60 ppm, or in a range of 10 ppm to 70 ppm. If a stabilizer distillation column is employed, the stabilized export crude oil 104 can be discharged as the bottom streams from the stabilizer distillation column and pumped via the column bottoms pump to storage or distribution.

The GOSP 100 can include a control system 112 that facilitates or directs operation of the GOSP 100. For instance, the control system 112 can direct control of the supply or discharge of flow streams (including flowrate) and associated control valves, control of operating temperatures and operating pressures, and so on. The control system 112 (or associated computer system) can perform salt mass-balance calculations of the GOSP 100 to determine (monitor) the salt content in the export crude oil 104. The determination can be based on on-line analysis upstream (internal) in the GOSP 100. The salt content in the export crude oil 104 can be determined in real time (or substantially real time) without online analysis of the export crude oil 104 itself. The salt content in the export crude oil 104 can be determined in real time (or substantially real time) with manual sampling and/or online analysis of the export crude oil 104.

In some implementations, the control system 112 can calculate or otherwise determine set points of control devices. For instance, the control system 112 can specify the set point of the flow control valve 114 (or specify number of strokes per time for a wash-water supply pump) on the wash water 116 supply to the desalter 118. In some cases, the set point of a control device can be input manually. In some cases, the set point of a control device can be calculated and/or adjusted by the control system 112.

The control system 112 can include a processor and memory storing code (e.g., logic, instructions, etc.) executed by the processor to perform calculations and direct operations of the GOSP 100. The processor (hardware processor) can be one or more processors and each processor can have one or more cores. The processor(s) can include a microprocessor, central processing unit (CPU), graphic processing unit (GPU), controller card, circuit board, or other circuitry. The memory can include volatile memory (for example, cache or random access memory), nonvolatile memory (for example, hard drive, solid-state drive, or read-only memory), and firmware. The control system 112 can include a desktop computer, laptop computer, computer server, control panels, programmable logic controller (PLC), distributed computing system (DSC), controllers, actuators, or control cards.

The control system 112 can be communicatively coupled to a remote computing system that performs calculations and provides direction. The control system 112 can receive user input or remote-computer input that specifies the set points of control devices or other control components in the GOSP 100. The control system 112 can employ local control panels distributed in the GOSP 100. Certain implementations can include a control room that can be a center of activity, facilitating monitoring and control of the GOSP 100 process or facility. The control room can contain a human machine interface (HMI), which is a computer, for example, that runs specialized software to provide a user-interface for the control system. The HMI can vary by vendor and present the user with a graphical version of the remote process. There can be multiple HMI consoles or workstations, with varying degrees of access to data.

As indicated, after dewatering the crude oil 102 emulsion in the phase separators HPPT 122 and LPPT 128 (and/or LPDT), the crude oil 138 stream undergoes a stage of desalting at each of the dehydrator 126 and the desalter 118. If not desalted, the small brine droplets contained in the crude oil 138 stream leaving the LPPT 128 (or LPDT) can corrode pipes and storage tanks. In addition to the corrosion of metallic equipment, high concentration of salts within these brine droplets could foul or plug trays in distillation columns, heat-exchanger tubes, etc. at downstream refineries. Therefore, the level of salt in the export crude oil 104 is regulated and controlled, for example, to under 10 pounds salt (as sodium chloride equivalent) per 1,000 barrels crude oil (10 lbm salt/1000 bbl crude oil or PTB) for transportation and storage, and to under 1 lbm salt/bbl crude oil for petroleum refineries. One pound salt per thousand barrels is equivalent to 28.5 gram of salt/m³ (or ppmw). In some examples, the water volume fraction (level of residual brine) can be regulated and controlled to maximum 0.5 volume percent (vol %) for heavy crude oils (e.g., Heavy Arabian crude oil) and maximum 0.2 vol % for other crude oils (e.g., Arabian crude oils). The water volume fraction can be regulated and controlled to other product-specification values (vol %) for water volume fraction as applicable for other types or grades of crude oil, or can be customer dependent. As indicated, aspects of the present disclosure can provide: (1) real-time, automated wash-water 116 flowrate to the desalter 118 for control of salt content in the export crude oil 104; and (2) real-time monitoring (via calculation) of the salt content in the export crude oil 104 that exits the desalter 118.

The low grade waste heat recovery system 150 includes a refrigeration loop 151 and a mixed refrigerant stream 153 flowing through the refrigeration loop 151. The mixed refrigerant stream 153 can include a mixture of components that exhibits the desired characteristics of vaporization and condensation at the operating conditions of the refrigeration loop 151. For example, the mixed refrigerant stream 153 can include a mixture of hydrocarbons, such as alkanes (for example, propane) and fluorinated alkanes. The mixed refrigerant stream 53 can include ethers and/or fluorinated ethers. The mixed refrigerant stream 153 receives waste heat from the GOSP 100 via waste heat recovery heat exchangers. For example, the system 150 includes a first waste heat recovery heat exchanger 154a, a second waste heat recovery heat exchanger 154b, and a third waste heat recovery heat exchanger 154c. A first portion 153a of the mixed refrigerant stream 153 flows through the first waste heat recovery heat exchanger 154a. A second portion 153b of the mixed refrigerant stream 153 flows through the second waste heat recovery heat exchanger 154b. A third portion 153c of the mixed refrigerant stream 153 flows through the third waste heat recovery heat exchanger 154c. In some cases, the system 150 can include additional waste heat recovery heat exchangers (for example, four, five, or more than five) for recovering additional waste heat produced by the GOSP 100. In such cases, additional portions of the mixed refrigerant stream 153 can flow separately to the additional waste heat recovery heat exchangers.

The LP compressor 152 pressurizes the gas 136 from the LPPT 128 to promote flow of the gas 136 through the first waste heat recovery heat exchanger 154a. In some implementations, the LP compressor 152 increases the pressure of the gas 136 and discharges the gas 136 at a discharge pressure in a range of from about 40 psig to about 100 psig, from about 50 psig to about 90 psig, or from about 60 psig to about 80 psig (for example, about 70 psig). Increasing the pressure of the gas 136 can result in increasing the temperature of the gas 136. In some implementations, the LP compressor 152 discharges the gas 136 at a discharge temperature in a range of from about 200° F. to about 300° F., from about 220° F. to about 280° F., or from about 240° F. to about 260° F. (for example, about 250° F.). The first portion 153a of the mixed refrigerant stream 153 enters the first waste heat recovery heat exchanger 154a in a liquid state. As the gas 136 and the first portion 153a of the mixed refrigerant stream 153 flow through the first waste heat recovery heat exchanger 154a, heat is transferred from the gas 136 to the first portion 153a of the mixed refrigerant stream 153. The gas 136 and the first portion 153a of the mixed refrigerant stream 153 do not come into direct contact with one another. Instead, the first waste heat recovery heat exchanger 154a provides an intermediary heat transfer area to facilitate transfer of heat from the gas 136 to the first portion 153a of the mixed refrigerant stream 153. The heat transferred from the gas 136 to the first portion 153a of the mixed refrigerant stream 153 by the first waste heat recovery heat exchanger 154a causes the first portion 153a of the mixed refrigerant stream 153 to at least partially vaporize. In some cases, the heat transferred from the gas 136 to the first portion 153a of the mixed refrigerant stream 153 by the first waste heat recovery heat exchanger 154a causes the first portion 153a of the mixed refrigerant stream 153 to completely vaporize. In some implementations, the gas 136 exiting the first waste heat recovery heat exchanger 154a (after transferring heat to the first portion 153a of the mixed refrigerant stream 153) has an operating temperature in a range of from about 70° F. to about 110° F., from about 80° F. to about 100° F., or from about 85° F. to about 95° F. (for example, about 90° F.). Downstream of the first waste heat recovery heat exchanger 154a, the gas 136 mixes with the gas 130 from the HPPT 122.

In some implementations, the mixture of the gas 136 and the gas 130 flows to a separator 158. The separator 158 can be referred to as a knockout drum. The separator 158 is sized to allow a liquid phase to condense and/or separate from the vapor phase of the mixture of the gas 136 and the gas 130. For example, the gas 138 that has been cooled by the first waste heat recovery heat exchanger 154a can have partially condensed, and the separator 158 separates the condensed liquid from the remaining vapor phase. The gas 160 exiting the separator 158 includes the remaining vapor portion of the mixture of the gas 136 and the gas 130 after the liquid phase has been separated. The liquid 161 exiting the separator 158 includes the liquid that has been separated from the vapor portion of the mixture of the gas 136 and the gas 130. In terms of mass balance, the gas 160 and the liquid 161 exiting the separator 158 have a sum total of mass that is equal to the mass of the mixture of the gas 136 and the gas 130 entering the separator 158.

The 1^{st} stage HP compressor 156 pressurizes the gas 160 from the separator 158 to promote flow of the gas 160 through the second waste heat recovery heat exchanger 154b. In some implementations, the 1^{st} stage HP compressor 156 increases the pressure of the gas 160 and discharges the gas 160 at a discharge pressure in a range of from about 200 psig to about 300 psig, from about 220 psig to about 280 psig, or from about 240 psig to about 260 psig (for example, about 245 psig). Increasing the pressure of the gas 160 can result in increasing the temperature of the gas 160. In some implementations, the 1^{st} stage HP compressor 156 discharges the gas 160 at a discharge temperature in a range of from about 220° F. to about 320° F., from about 240° F. to about 300° F., or from about 260° F. to about 280° F. (for example, about 270° F.). The second portion 153b of the mixed refrigerant stream 153 enters the second waste heat recovery heat exchanger 154b in a liquid state. As the gas 160 and the second portion 153b of the mixed refrigerant stream 153 flow through the second waste heat recovery heat exchanger 154b, heat is transferred from the gas 160 to the second portion 153b of the mixed refrigerant stream 153. The gas 160 and the second portion 153b of the mixed refrigerant stream 153 do not come into direct contact with one another. Instead, the second waste heat recovery heat exchanger 154b provides an intermediary heat transfer area to facilitate transfer of heat from the gas 160 to the second portion 153b of the mixed refrigerant stream 153. The heat transferred from the gas 160 to the second portion 153b of the mixed refrigerant stream 153 by the second waste heat recovery heat exchanger 154b causes the second portion 153b of the mixed refrigerant stream 153 to at least partially vaporize. In some cases, the heat transferred from the gas 160 to the second portion 153b of the mixed refrigerant stream 153 by the second waste heat recovery heat exchanger 154b causes the second portion 153b of the mixed refrigerant stream 153 to completely vaporize. In some implementations, the gas 160 exiting the second waste heat recovery heat exchanger 154b (after transferring heat to the second portion 153b of the mixed refrigerant stream 153) has an operating temperature in a range of from about 70° F. to about 110° F., from about 80° F. to about 100° F., or from about 85° F. to about 95° F. (for example, about 90° F.).

In some implementations, the gas 160 flows to a separator 162. The separator 162 can be referred to as a knockout drum and can be substantially similar to the separator 158. The separator 162 is sized to allow a liquid phase to condense and/or separate from the vapor phase of the gas 160. For example, the gas 160 that has been cooled by the second waste heat recovery heat exchanger 154b can have partially condensed, and the separator 162 separates the condensed liquid from the remaining vapor phase. The gas 164 exiting the separator 162 includes the remaining vapor portion of the gas 164 after the liquid phase has been separated. The separator 158 can be configured to separate immiscible liquid phases. For example, the separator 158 can be sized to separate an aqueous liquid phase 165a (water) from a non-aqueous liquid phase 165b (e.g., oil). The aqueous liquid phase 165a can include, for example, brine. The non-aqueous liquid phase 165b can include, for example, condensate (hydrocarbon(s)) that has condensed from the gas 160. In terms of mass balance, the gas 164, the aqueous liquid phase 165a, and the non-aqueous liquid phase 165b exiting the separator 162 have a sum total of mass that is equal to the mass of the gas 160 entering the separator 162.

A 2^{nd} stage HP compressor 166 pressurizes the gas 164 from the separator 162 to promote flow of the gas 164 through the third waste heat recovery heat exchanger 154c. In some implementations, the 2^{nd} stage HP compressor 166 increases the pressure of the gas 164 and discharges the gas 164 at a discharge pressure in a range of from about 440 psig to about 540 psig, from about 460 psig to about 520 psig, or from about 480 psig to about 500 psig (for example, about 490 psig). Increasing the pressure of the gas 164 can result in increasing the temperature of the gas 164. In some implementations, the 2^{nd} stage HP compressor 166 discharges the gas 164 at a discharge temperature in a range of from about 120° F. to about 220° F., from about 140° F. to about 200° F., or from about 160° F. to about 180° F. (for example, about 170° F.). The third portion 153c of the mixed refrigerant stream 153 enters the third waste heat recovery heat exchanger 154c in a liquid state. As the gas 164 and the third portion 153c of the mixed refrigerant stream 153 flow through the third waste heat recovery heat exchanger 154c, heat is transferred from the gas 164 to the third portion 153c of the mixed refrigerant stream 153. The gas 164 and the third portion 153c of the mixed refrigerant stream 153 do not come into direct contact with one another. Instead, the third waste heat recovery heat exchanger 154c provides an intermediary heat transfer area to facilitate transfer of heat from the gas 164 to the third portion 153b of the mixed refrigerant stream 153. The heat transferred from the gas 164 to the third portion 153c of the mixed refrigerant stream 153 by the third waste heat recovery heat exchanger 154c causes the third portion 153c of the mixed refrigerant stream 153 to at least partially vaporize. In some cases, the heat transferred from the gas 164 to the third portion 153c of the mixed refrigerant stream 153 by the third waste heat recovery heat exchanger 154c causes the third portion 153c of the mixed refrigerant stream 153 to completely vaporize. In some implementations, the gas 164 exiting the third waste heat recovery heat exchanger 154c (after transferring heat to the third portion 153c of the mixed refrigerant stream 153) has an operating temperature in a range of from about 70° F. to about 110° F., from about 80° F. to about 100° F., or from about 85° F. to about 95° F. (for example, about 90° F.).

In some implementations, the gas 164 flows to a separator 168. The separator 168 can be referred to as a knockout drum and can be substantially similar to the separator 162. The separator 168 is sized to allow a liquid phase to condense and/or separate from the vapor phase of the gas 164. For example, the gas 164 that has been cooled by the third waste heat recovery heat exchanger 154c can have partially condensed, and the separator 168 separates the condensed liquid from the remaining vapor phase. The gas 170 exiting the separator 168 includes the remaining vapor portion of the gas 164 after the liquid phase has been separated. The separator 168 can be configured to separate immiscible liquid phases. For example, the separator 168 can be sized to separate an aqueous liquid phase 171a (water) from a non-aqueous liquid phase 171b (e.g., oil). The aqueous liquid phase 171a can include, for example, brine. The non-aqueous liquid phase 171b can include, for example, condensate (hydrocarbon(s)) that has condensed from the gas 164. In terms of mass balance, the gas 170, the aqueous liquid phase 171a, and the non-aqueous liquid phase 171b exiting the separator 168 have a sum total of mass that is equal to the mass of the gas 164 entering the separator 168.

After the first portion 153a, second portion 153b, and third portion 153c of the mixed refrigerant stream 153 recover waste heat from the GOSP 100 via the first waste heat recovery heat exchanger 154a, second waste heat recovery heat exchanger 154b, and third waste heat recovery heat exchanger 154c, respectively, the portions (153a, 153b, 153c) of the mixed refrigerant stream 153 combine to reform the mixed refrigerant stream 153′ in the refrigeration loop 151. As described previously, the portions (153a, 153b, 153c) of the mixed refrigerant stream 153 are at least partially in a vapor state directly downstream of the first waste heat recovery heat exchanger 154a, second waste heat recovery heat exchanger 154b, and third waste heat recovery heat exchanger 154c. Thus, the combined mixed refrigerant stream 153′ downstream of the first waste heat recovery heat exchanger 154a, second waste heat recovery heat exchanger 154b, and third waste heat recovery heat exchanger 154c is also at least partially in a vapor state. In some cases, the combined mixed refrigerant stream 153 downstream of the first waste heat recovery heat exchanger 154a, second waste heat recovery heat exchanger 154b, and third waste heat recovery heat exchanger 154c is fully in a vapor state (100% vapor).

The combined mixed refrigerant stream 153′ flows to a turbine-generator 172. In some implementations, the combined mixed refrigerant stream 153′ flows through a knockout drum (not shown) prior to entering the turbine-generator 172. The knockout drum can be sized and designed to separate any potential condensed liquid from the combined mixed refrigerant stream 153′ as a safety measure for protecting the turbine-generator 172 against any liquid from entering the turbine-generator 172. The turbine-generator 172 includes turbine blades 172a coupled to a rotor 172b. The combined mixed refrigerant stream 153′ flowing through the turbine-generator 172 causes the turbine blades 172a of the turbine-generator 172 to rotate. Because the rotor 172b of the turbine-generator 172 is coupled to the turbine blades 172a, the rotor 172b rotates with the turbine blades 172a. The turbine-generator 172 is configured to generate electrical power in response to rotation of the rotor 172b. In this manner, the low grade waste heat recovery system 150 utilizes the low grade waste heat recovered from the GOSP 100 (via the mixed refrigerant stream 153′) to generate useful electrical power. The electrical power generated by the turbine-generator 172 can, for example, be used within the low grade waste heat recovery system 150, within the GOSP 100, be provided to an end user, be provided to a power grid, or any combinations of these.

In some implementations, the low grade waste heat recovery system 150 includes a first condenser 174 and a second condenser 176. The first condenser 174 can include a first side 174a and a second side 174b. The first condenser 174 can, for example, be a shell-and-tube heat exchanger in which the first side 174a is a shell side, and the second side 174b is a tube side. The first side 174a is configured to receive the combined mixed refrigerant stream 153′ from the turbine-generator 172. As the combined mixed refrigerant stream 153′ flows through the first side 174a of the first condenser 174, the combined mixed refrigerant stream 153′ is cooled. In some cases, the combined mixed refrigerant stream 153′ at least partially condenses in the first side 174a of the first condenser 174. In some cases, the combined mixed refrigerant stream 153′ fully condenses in the first side 174a of the first condenser 174. The combined mixed refrigerant stream 153′ exiting the first side 174a of the first condenser 174 flows to the second condenser 176. The second condenser 176 can, for example, be a shell-and-tube heat exchanger or a fin-fan air cooler. The combined mixed refrigerant stream 153′ flowing from the first side 174a of the first condenser 174 to the second condenser 176 can be in a mixed phase state (for example, liquid and vapor) or a liquid state. As the combined mixed refrigerant stream 153′ flows through the second condenser 176, the combined mixed refrigerant stream 153′ is further cooled. Regardless of what state (liquid and vapor or just liquid) the combined mixed refrigerant stream 153′ enters the second condenser 176, the second condenser 174 provides sufficient cooling duty, such that the combined mixed refrigerant stream 153′ exiting the second condenser 176 is in a fully liquid state. In most cases, the second condenser 176 subcools the mixed refrigerant stream 153′ to a temperature less than the saturation temperature of the mixed refrigerant stream 153′. The subcooled mixed refrigerant stream 153′ flows from the second condenser 176 to a pump 178. The pump 178 pressurizes the mixed refrigerant stream 153′ to facilitate flow of the mixed refrigerant stream 153′ through the refrigeration loop 151. The pump 178 can, for example, be a centrifugal pump, a positive-displacement pump, or an axial-flow pump. The second condenser 176 can be sized and designed to provide sufficient cooling duty to the mixed refrigerant stream 153′ to prevent vaporization of the mixed refrigerant stream 153′ as it flows through the pump 178 as a safety measure for protecting the pump 178 against cavitation. The mixed refrigerant stream 153′ flows from the pump 178 to the second side 174b of the first condenser 174. As the mixed refrigerant stream 153′ flows through the second side 174b of the first condenser 174, the mixed refrigerant stream 153′ is heated. As such, the first condenser 174 performs heat integration in that the mixed refrigerant stream 153′ (flowing through the first side 174a) transfers heat to itself through the first condenser 174 (flowing through the second side 174b). The first condenser 174 heats the mixed refrigerant stream 153′ to a temperature at which the mixed refrigerant stream 153 is regenerated and prepared for recovering waste heat from the GOSP 100 via the first waste heat recovery heat exchanger 154a, second waste heat recovery heat exchanger 154b, and third waste heat recovery heat exchanger 154c. After exiting the second side 174b of the first condenser 174, the mixed refrigerant stream 153 splits into the first portion 153a, the second portion 153b, and the third portion 153c. The first portion 153a of the mixed refrigerant stream 153 flows to the first waste heat recovery heat exchanger 154a, the second portion 153b of the mixed refrigerant stream 153 flows to the second waste heat recovery heat exchanger 154b, and the third portion 153c of the mixed refrigerant stream 153 flows to the third waste heat recovery heat exchanger 154c. The mixed refrigerant stream 153 cycles through the refrigeration loop 151 in this manner.

Although shown in FIG. 1 as including two condensers (174, 176), the low grade waste heat recovery system 150 can alternatively include fewer condensers (for example, a single condenser) or more condensers (for example, three or more condensers). In cases in which the low grade waste heat recovery system 150 includes only a single condenser as opposed to the two condensers 174, 176, the single condenser can be sized and designed to provide sufficient cooling duty to fully condense and subcool the mixed refrigerant stream 153′ to prevent vaporization of the mixed refrigerant stream 153′ as it flows through the pump 178 to prevent cavitation.

The GOSP 100 can include a glycol dehydration unit 180. The glycol dehydration unit 180 processes gas separated from the crude oil 102 to remove water. For example, the glycol dehydration unit 180 dehydrates the gas 170 from the separator 168 to produce a dry gas 182. The glycol dehydration unit 180 can include typical equipment that is known in the art for dehydrating natural gas. For example, the glycol dehydration unit 180 includes a glycol contactor and a glycol regenerator (which is essentially a distillation column). The dry gas 182 can, for example, be flowed to a gas processing unit for further processing (for example, a sweetening process for removing hydrogen sulfide). Processing the gas 170 by the glycol dehydration unit 180 can include causing heavier hydrocarbons of the gas 170 to condense and separate prior to dehydrating the gas 170. In such cases, the glycol dehydration unit 180 can produce a condensate stream 184. Condensing the heavier hydrocarbons of the gas 170 to produce the condensate stream 184 can include the use of a separate refrigeration system (for example, a propane refrigeration system). Integrating the GOSP 100 with the low grade heat recovery system 150 can reduce the refrigeration load of this refrigeration system of the glycol dehydration unit 180. In some cases, the refrigeration load of the refrigeration system of the glycol dehydration unit 180 can be decreased by about 90% due to the cooling that the low grade heat recovery system 150 provides to the GOSP 100.

The condensate stream 184 from the glycol dehydration unit 180, the non-aqueous liquid phase 165b from the separator 162 (also considered condensate), and the non-aqueous liquid phase 171b from the separator 168 (also considered condensate) flow to a condensate stripper 186. The condensate stripper 186 can, for example, be a distillation column. The condensate stripper 186 can include typical equipment that is known in the art for fractionation (such as a reboiler). The condensate stripper 186 fractionates the received condensate (162, 168, 184) to produce an overhead vapor stream 188 as distillate and a natural gas liquids (NGL) stream 190 as bottoms. In some implementations, the overhead vapor stream 188 is flowed with the dry gas 182 to the gas processing unit for further processing. In some implementations, the overhead vapor stream 188 is recycled to the separator 162, so that additional waste heat produced by the GOSP 100 can be recovered by the low grade waste heat recovery system 150. The NGL stream 190 can, for example, be flowed to a NGL fractionation unit for further processing (for example, a fractionation process for separating components of the NGL stream 190).

Implementation of the low grade waste heat recovery system 150 not only recovers low grade waste heat produced by the GOSP 100 to generate useful electrical power, but also increases the amount of condensate (NGL) produced by the GOSP 100. In some implementations, the flow rate of the NGL stream 190 produced by the GOSP 100 is increased by at least 5%, by at least 6%, or by at least 7% when compared to a control/conventional GOSP that is not integrated with the low grade waste heat recovery system 150 for capturing low grade waste heat from the GOSP 100. For example, a control/conventional GOSP (without the low grade waste heat recovery system 150) can produce an NGL stream at a flow rate of only about 43,230 barrels per day (bbl/d), while the GOSP 100 (integrated with the low grade waste heat recovery system 150) can produce the NGL stream 190 at a flow rate of 46,450 bbl/d (about a 7.4% increase in flow). The increased flow of the NGL stream 190 produced by the GOSP 100 can be attributed to the cooling the low grade waste heat recovery system 100 provides as it recovers waste heat generated by the GOSP 100, thereby decreasing the operating temperatures of the various gases (130, 136, 150, 164, 170) flowing in the GOSP 100 and allowing additional hydrocarbon liquids to condense from the gases.

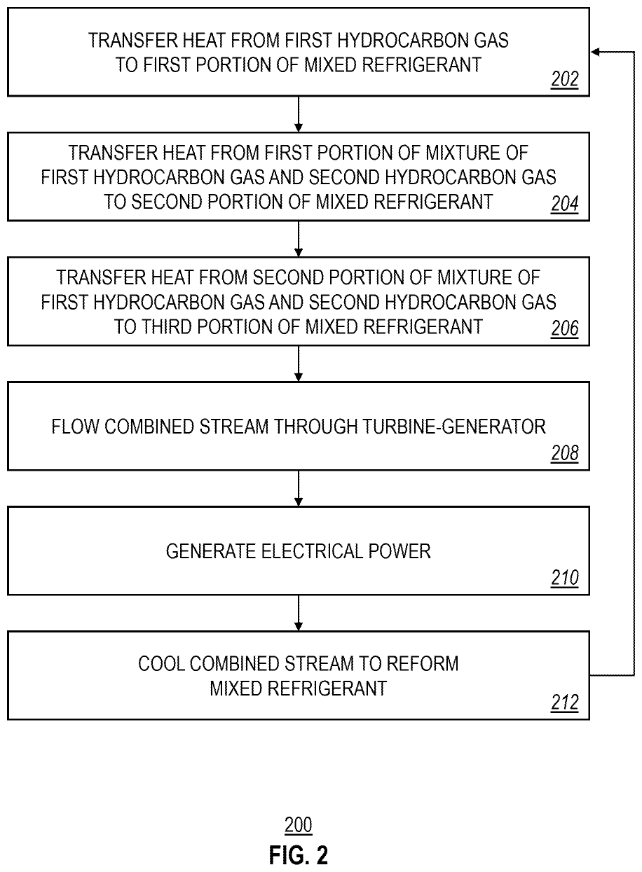

FIG. 2 is a flow chart of an example method 200 for capturing low grade waste heat in a GOSP (such as the GOSP 100). The GOSP 100 including the low grade waste heat recovery system 150 can, for example, implement the method 200. At block 202, heat is transferred from a first hydrocarbon stream to a first portion of a mixed refrigerant to vaporize the first portion of the mixed refrigerant stream. For example, heat is transferred from the gas 136 (from the LPPT 128 and compressed by LP compressor 152) to the first portion 153a of the mixed refrigerant stream 153 to vaporize the first portion 153a of the mixed refrigerant stream 153 at block 202. The first hydrocarbon stream at block 202 is separated from a crude oil stream by a first separator positioned in the GOSP. For example, the gas 136 is separated from the crude oil 132 by the LPPT 128 positioned in the GOSP 100. The heat can be transferred from the gas 136 to the first portion 153a of the mixed refrigerant stream 153 at block 202 by the first waste heat recovery heat exchanger 154a.

At block 204, heat is transferred from a first portion of a mixture of the first hydrocarbon gas stream and a second hydrocarbon gas stream to a second portion of the mixed refrigerant stream to vaporize the second portion of the mixed refrigerant stream. For example, heat is transferred from the gas 150 (which is the vapor portion of the mixture of the gas 130 from the HPPT 122 and the gas 136 from the LPPT 128, downstream of the separator 158) to the second portion 153b of the mixed refrigerant stream 153 to vaporize the second portion of the mixed refrigerant stream 153 at block 204. The second hydrocarbon gas stream is separated from the crude oil stream by a second separator positioned in the GOSP. For example, the gas 130 is separated from the crude oil 102 by the HPPT 122 positioned in the GOSP 100. The heat can be transferred from the gas 150 to the second portion 153b of the mixed refrigerant stream 153 at block 204 by the second waste heat recovery heat exchanger 154b.

At block 206, heat is transferred from a second portion of the mixture to a third portion of the mixed refrigerant stream to vaporize the third portion of the mixed refrigerant stream. For example, heat is transferred from the gas 164 (which is the vapor portion of the gas 150, downstream of the separator 162) to the third portion 153c of the mixed refrigerant stream 153 to vaporize the third portion 153c of the mixed refrigerant stream 153 at block 206. The heat can be transferred from the gas 164 to the third portion 153c of the mixed refrigerant stream 153 at block 206 by the third waste heat recovery heat exchanger 154c.

At block 208, a combined stream is flowed through a turbine-generator, in which the combined stream includes the vaporized first, second, and third portions of the mixed refrigerant stream. For example, the combined mixed refrigerant stream 153′ (including the vaporized first, second, and third portions (153a, 153b, 153c) of the mixed refrigerant stream 153) is flowed through the turbine-generator 172 at block 208. Flowing the combined mixed refrigerant stream 153′ through the turbine-generator 172 at block 208 causes the turbine blades 172a of the turbine-generator 172 to rotate. The rotor 172b of the turbine-generator 172 is coupled to the turbine blades 172a and rotates with the turbine blades 172a, as the combined mixed refrigerant stream 153′ flows through the turbine-generator 172 at block 208.

At block 210, electrical power is generated in response to rotation of the rotor of the turbine-generator. For example, electrical power is generated in response to rotation of the rotor 172b of the turbine-generator 172 at block 210.

At block 212, the combined stream from the turbine-generator is cooled to condense the combined stream to reform the mixed refrigerant stream in a liquid state. For example, the combined mixed refrigerant stream 153′ is cooled at block 212 to condense the combined mixed refrigerant stream 153′ to reform the mixed refrigerant stream 153 in a liquid state. The combined mixed refrigerant stream 153′ can be cooled at block 212 by the condensers 174 and 176. The method 200 can be repeated at block 202, as the mixed refrigerant stream 153 cycles through the refrigeration loop 151 in the low grade waste heat recovery system 150.

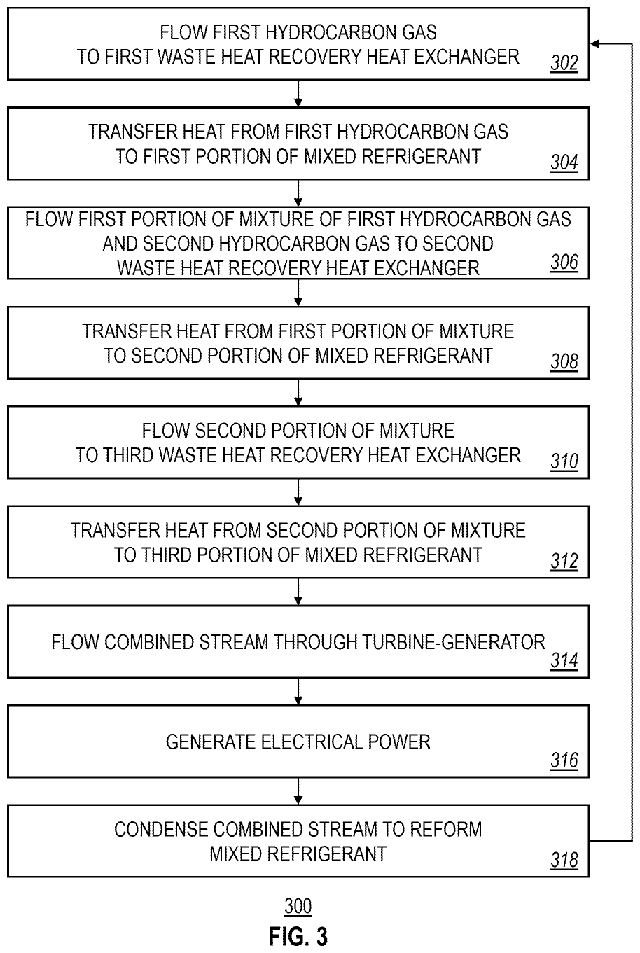

FIG. 3 is a flow chart of an example method 300 for capturing low grade waste heat in the GOSP 100. At block 302, a first hydrocarbon gas stream (136) is flowed to a first waste heat recovery heat exchanger (154a). The first hydrocarbon gas stream (136) is separated from a crude oil stream (102/132) by a first separator (128) positioned in the GOSP 100. At block 304, the first waste heat recovery heat exchanger (154a) transfers heat from the first hydrocarbon gas stream (136) to a first portion (153a) of a mixed refrigerant stream (153) to vaporize the first portion (153a) of the mixed refrigerant stream (153). At block 306, a first portion of a mixture (160) of the first hydrocarbon gas stream (136) and a second hydrocarbon gas stream (130) to a second waste heat recovery heat exchanger (154b). The second hydrocarbon gas stream (130) is separated from the crude oil stream (102) by a second separator (122) positioned in the GOSP 100. At block 308, the second waste heat recovery heat exchanger (154b) transfers heat from the first portion of the mixture (160) to a second portion (153b) of the mixed refrigerant stream (153) to vaporize the second portion (153b) of the mixed refrigerant stream (153). At block 310, a second portion of the mixture (164) is flowed to a third waste heat recovery heat exchanger (154c). At block 312, the third waste heat recovery heat exchanger (154c) transfers heat from the second portion of the mixture (164) to a third portion (153c) of the mixed refrigerant stream (153) to vaporize the third portion (153c) of the mixed refrigerant stream (153). At block 314, a combined stream (153′) is flowed through a turbine-generator (172). The combined stream (153′) includes the vaporized first, second, and third portions (153a, 153b, 153c) of the mixed refrigerant stream (153). Flowing the combined stream (153′) through the turbine-generator (172) causes a rotor (172b) of the turbine-generator 172 to rotate. At block 316, electrical power is generated in response to rotation of the rotor (172b) of the turbine-generator (172). At block 318, the combined stream (153′) from the turbine-generator (172) is condensed to reform the mixed refrigerant stream (153) in a liquid state. The method 300 can be repeated at block 302, as the mixed refrigerant stream 153 cycles through the refrigeration loop 151 in the low grade waste heat recovery system 150.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading can occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

### Embodiments

In an example implementation (or aspect), method for capturing low grade waste heat in a gas-oil separation plant (GOSP) comprises: transferring heat from a first hydrocarbon gas stream to a first portion of a mixed refrigerant stream to vaporize the first portion of the mixed refrigerant stream, wherein the first hydrocarbon gas stream is separated from a crude oil stream by a first separator positioned in the GOSP; transferring heat from a first portion of a mixture of the first hydrocarbon gas stream and a second hydrocarbon gas stream to a second portion of the mixed refrigerant stream to vaporize the second portion of the mixed refrigerant stream, wherein the second hydrocarbon gas stream is separated from the crude oil stream by a second separator positioned in the GOSP; transferring heat from a second portion of the mixture to a third portion of the mixed refrigerant stream to vaporize the third portion of the mixed refrigerant stream; flowing a combined stream through a turbine-generator, wherein the combined stream comprises the vaporized first, second, and third portions of the mixed refrigerant stream, wherein flowing the combined stream through the turbine-generator causes a rotor of the turbine-generator to rotate; generating electrical power in response to rotation of the rotor of the turbine-generator; and cooling the combined stream from the turbine-generator to condense the combined stream to reform the mixed refrigerant stream in a liquid state.

In an example implementation (or aspect) combinable with any other example implementation (or aspect), cooling the combined stream comprises: flowing the combined stream through a first side of a first heat exchanger; flowing the combined stream from the first side of the first heat exchanger through a second heat exchanger; and flowing the combined stream from the second heat exchanger through a second side of the first heat exchanger, wherein the combined stream flowing through the first side of the first heat exchanger transfers heat to the combined stream flowing through the second side of the first heat exchanger.

In an example implementation (or aspect) combinable with any other example implementation (or aspect), after transferring heat from the first hydrocarbon gas stream to the first portion of the mixed refrigerant stream, separating phases of the mixture to produce a first aqueous liquid phase and the first portion of the mixture, wherein the first portion of the mixture is in a vapor state prior to transferring heat from the first portion of the mixture to the second portion of the mixed refrigerant stream.

In an example implementation (or aspect) combinable with any other example implementation (or aspect), transferring heat from the first portion of the mixture to the second portion of the mixed refrigerant stream facilitates at least partial condensation of the first portion of the mixture, wherein the method comprises, after transferring heat from the first portion of the mixture to the second portion of the mixed refrigerant stream, separating phases of the first portion of the mixture to produce a second aqueous liquid phase, a first non-aqueous liquid phase, and the second portion of the mixture, wherein the second portion of the mixture is in a vapor state prior to transferring heat from the second portion of the mixture to the third portion of the mixed refrigerant stream.

In an example implementation (or aspect) combinable with any other example implementation (or aspect), transferring heat from the second portion of the mixture to the third portion of the mixed refrigerant stream facilitates at least partial condensation of the second portion of the mixture, wherein the method comprises, after transferring heat from the second portion of the mixture to the third portion of the mixed refrigerant stream, separating phases of the second portion of the mixture to produce a third aqueous liquid phase, a second non-aqueous liquid phase, and a fourth portion of the mixture.

In an example implementation (or aspect) combinable with any other example implementation (or aspect), fractionating the first non-aqueous liquid phase and the second non-aqueous liquid phase to produce an overhead vapor stream as distillate and a natural gas liquids (NGL) stream as bottoms, wherein a rate at which the NGL stream is produced by the GOSP is increased by at least 5% when compared to a control GOSP that does not capture low grade waste heat from the first hydrocarbon stream, the first portion of the mixture, and the second portion of the mixture.

In an example implementation (or aspect), a low grade waste heat capture system comprises: a first hydrocarbon gas stream separated from a crude oil stream by a first separator positioned in a gas-oil separation plant (GOSP); a second hydrocarbon gas stream separated from the crude oil stream by a second separator positioned in the GOSP; and a refrigeration loop comprising: a mixed refrigerant stream in a liquid state; a first waste heat recovery heat exchanger configured to transfer heat from the first hydrocarbon gas stream to a first portion of the mixed refrigerant stream to vaporize the first portion of the mixed refrigerant stream; a second waste heat recovery heat exchanger configured to transfer heat from a first portion of a mixture of the first hydrocarbon gas stream and the second hydrocarbon gas stream to a second portion of the mixed refrigerant stream to vaporize the second portion of the mixed refrigerant stream; a third waste heat recovery heat exchanger configured to transfer heat from a second portion of the mixture to a third portion of the mixed refrigerant stream to vaporize the third portion of the mixed refrigerant stream; a turbine-generator configured to receive a combined stream comprising the vaporized first, second, and third portions of the mixed refrigerant stream, the turbine-generator comprising turbine blades coupled to a rotor, the turbine blades configured to rotate in response to flow of the combined stream through the turbine-generator, the rotor configured to rotate with the turbine blades, the turbine-generator configured to generate electrical power in response to rotation of the rotor; and a condenser configured to cool the combined stream from the turbine-generator to condense the combined stream to reform the mixed refrigerant stream in the liquid state.

In an example implementation (or aspect) combinable with any other example implementation (or aspect), the condenser is a first condenser comprising a first side and a second side; the first side of the first condenser is configured to receive the combined stream from the turbine-generator; and the system comprises a second condenser configured to receive and cool the combined stream from the first side of the first condenser.

In an example implementation (or aspect) combinable with any other example implementation (or aspect), the second side of the first condenser is configured to receive the combined stream from the second condenser, wherein the first condenser is configured to transfer heat from the combined stream at the first side to the combined stream at the second side.

In an example implementation (or aspect) combinable with any other example implementation (or aspect), comprising a third separator configured to receive and separate phases of the mixture to produce a first aqueous liquid phase and the first portion of the mixture, wherein the first portion of the mixture is in a vapor state prior to entering the second waste heat recovery heat exchanger.

In an example implementation (or aspect) combinable with any other example implementation (or aspect), transferring heat from the first portion of the mixture to the second portion of the mixed refrigerant stream by the second waste heat recovery heat exchanger facilitates at least partial condensation of the first portion of the mixture, wherein the system comprises a fourth separator configured to receive the first portion of the mixture from the second waste heat recovery heat exchanger, wherein the fourth separator is configured to separate phases of the first portion of the mixture to produce a second aqueous liquid phase, a first non-aqueous liquid phase, and the second portion of the mixture, wherein the second portion of the mixture is in a vapor state prior to entering the third waste heat recovery heat exchanger.

In an example implementation (or aspect) combinable with any other example implementation (or aspect), transferring heat from the second portion of the mixture to the third portion of the mixed refrigerant stream by the third waste heat recovery heat exchanger facilitates at least partial condensation of the second portion of the mixture, wherein the system comprises a fifth separator configured to receive the second portion of the mixture from the third waste heat recovery heat exchanger, wherein the fifth separator is configured to separate phases of the second portion of the mixture to produce a third aqueous liquid phase, a second non-aqueous liquid phase, and a fourth portion of the mixture.

In an example implementation (or aspect) combinable with any other example implementation (or aspect), comprising a distillation column configured to receive and fractionate the first non-aqueous liquid phase and the second non-aqueous phase to produce an overhead vapor stream as distillate and a natural gas liquids (NGL) stream as bottoms, wherein a rate at which the NGL stream is produced by the GOSP is increased by at least 5% when compared to a control GOSP that does not capture low grade waste heat from the first hydrocarbon stream, the first portion of the mixture, and the second portion of the mixture via the first waste heat recovery heat exchanger, the second waste heat recovery heat exchanger, and the third waste heat recovery heat exchanger, respectively.

In an example implementation (or aspect), a method comprises: flowing a first hydrocarbon gas stream to a first waste heat recovery heat exchanger, wherein the first hydrocarbon gas stream is separated from a crude oil stream by a first separator positioned in a gas-oil separation plant (GOSP); transferring, by the first waste heat recovery heat exchanger, heat from the first hydrocarbon gas stream to a first portion of a mixed refrigerant stream to vaporize the first portion of the mixed refrigerant stream; flowing a first portion of a mixture of the first hydrocarbon gas stream and a second hydrocarbon gas stream to a second waste heat recovery heat exchanger, wherein the second hydrocarbon gas stream is separated from the crude oil stream by a second separator positioned in the GOSP; transferring, by the second waste heat recovery heat exchanger, heat from the first portion of the mixture to a second portion of the mixed refrigerant stream to vaporize the second portion of the mixed refrigerant stream; flowing a second portion of the mixture to a third waste heat recovery heat exchanger; transferring, by the third waste heat recovery heat exchanger, heat from the second portion of the mixture to a third portion of the mixed refrigerant stream to vaporize the third portion of the mixed refrigerant stream; flowing a combined stream through a turbine-generator, wherein the combined stream comprises the vaporized first, second, and third portions of the mixed refrigerant stream, wherein flowing the combined stream through the turbine-generator causes a rotor of the turbine-generator to rotate; generating electrical power in response to rotation of the rotor of the turbine-generator; and condensing the combined stream from the turbine-generator to reform the mixed refrigerant stream in a liquid state.

In an example implementation (or aspect) combinable with any other example implementation (or aspect), condensing the combined stream comprises: flowing the combined stream through a first side of a first heat exchanger; flowing the combined stream from the first side of the first heat exchanger through a second heat exchanger; and flowing the combined stream from the second heat exchanger through a second side of the first heat exchanger, wherein the combined stream flowing through the first side of the first heat exchanger transfers heat to the combined stream flowing through the second side of the first heat exchanger.

In an example implementation (or aspect) combinable with any other example implementation (or aspect), after transferring heat from the first hydrocarbon gas stream to the first portion of the mixed refrigerant stream, separating phases of the mixture to produce a first aqueous liquid phase and the first portion of the mixture, wherein the first portion of the mixture is in a vapor state prior to transferring heat from the first portion of the mixture to the second portion of the mixed refrigerant stream.

In an example implementation (or aspect) combinable with any other example implementation (or aspect), transferring heat from the first portion of the mixture to the second portion of the mixed refrigerant stream facilitates at least partial condensation of the first portion of the mixture, wherein the method comprises, after transferring heat from the first portion of the mixture to the second portion of the mixed refrigerant stream, separating phases of the first portion of the mixture to produce a second aqueous liquid phase, a first non-aqueous liquid phase, and the second portion of the mixture, wherein the second portion of the mixture is in a vapor state prior to transferring heat from the second portion of the mixture to the third portion of the mixed refrigerant stream.

In an example implementation (or aspect) combinable with any other example implementation (or aspect), transferring heat from the second portion of the mixture to the third portion of the mixed refrigerant stream facilitates at least partial condensation of the second portion of the mixture, wherein the method comprises, after transferring heat from the second portion of the mixture to the third portion of the mixed refrigerant stream, separating phases of the second portion of the mixture to produce a third aqueous liquid phase, a second non-aqueous liquid phase, and a fourth portion of the mixture.

In an example implementation (or aspect) combinable with any other example implementation (or aspect), fractionating the first non-aqueous liquid phase and the second non-aqueous liquid phase to produce an overhead vapor stream as distillate and a natural gas liquids (NGL) stream as bottoms, wherein a rate at which the NGL stream is produced by the GOSP is increased by at least 5% when compared to a control GOSP that does not capture low grade waste heat from the first hydrocarbon stream, the first portion of the mixture, and the second portion of the mixture.

What is claimed is:

1. A method for capturing low grade waste heat in a gas-oil separation plant (GOSP), the method comprising:
transferring heat from a first hydrocarbon gas stream to a first portion of a mixed refrigerant stream to vaporize the first portion of the mixed refrigerant stream, wherein the first hydrocarbon gas stream is separated from a crude oil stream by a first separator positioned in the GOSP;
transferring heat from a first portion of a mixture of the first hydrocarbon gas stream and a second hydrocarbon gas stream to a second portion of the mixed refrigerant stream to vaporize the second portion of the mixed refrigerant stream, wherein the second hydrocarbon gas stream is separated from the crude oil stream by a second separator positioned in the GOSP;
transferring heat from a second portion of the mixture to a third portion of the mixed refrigerant stream to vaporize the third portion of the mixed refrigerant stream;
flowing a combined stream through a turbine-generator, wherein the combined stream comprises the vaporized first, second, and third portions of the mixed refrigerant stream, wherein flowing the combined stream through the turbine-generator causes a rotor of the turbine-generator to rotate;
generating electrical power in response to rotation of the rotor of the turbine-generator; and
cooling the combined stream from the turbine-generator to condense the combined stream to reform the mixed refrigerant stream in a liquid state.

2. The method of claim 1, wherein cooling the combined stream comprises:
flowing the combined stream through a first side of a first heat exchanger;
flowing the combined stream from the first side of the first heat exchanger through a second heat exchanger; and
flowing the combined stream from the second heat exchanger through a second side of the first heat exchanger, wherein the combined stream flowing through the first side of the first heat exchanger transfers heat to the combined stream flowing through the second side of the first heat exchanger.

3. The method of claim 2, comprising, after transferring heat from the first hydrocarbon gas stream to the first portion of the mixed refrigerant stream, separating phases of the mixture to produce a first aqueous liquid phase and the first portion of the mixture, wherein the first portion of the mixture is in a vapor state prior to transferring heat from the first portion of the mixture to the second portion of the mixed refrigerant stream.

4. The method of claim 3, wherein transferring heat from the first portion of the mixture to the second portion of the mixed refrigerant stream facilitates at least partial condensation of the first portion of the mixture, wherein the method comprises, after transferring heat from the first portion of the mixture to the second portion of the mixed refrigerant stream, separating phases of the first portion of the mixture to produce a second aqueous liquid phase, a first non-aqueous liquid phase, and the second portion of the mixture, wherein the second portion of the mixture is in a vapor state prior to transferring heat from the second portion of the mixture to the third portion of the mixed refrigerant stream.

5. The method of claim 4, wherein transferring heat from the second portion of the mixture to the third portion of the mixed refrigerant stream facilitates at least partial condensation of the second portion of the mixture, wherein the method comprises, after transferring heat from the second portion of the mixture to the third portion of the mixed refrigerant stream, separating phases of the second portion of the mixture to produce a third aqueous liquid phase, a second non-aqueous liquid phase, and a fourth portion of the mixture.

6. The method of claim 5, comprising fractionating the first non-aqueous liquid phase and the second non-aqueous liquid phase to produce an overhead vapor stream as distillate and a natural gas liquids (NGL) stream as bottoms, wherein a rate at which the NGL stream is produced by the GOSP is increased by at least 5% when compared to a control GOSP that does not capture low grade waste heat from the first hydrocarbon stream, the first portion of the mixture, and the second portion of the mixture.

7. A low grade waste heat capture system comprising:
a first hydrocarbon gas stream separated from a crude oil stream by a first separator positioned in a gas-oil separation plant (GOSP);
a second hydrocarbon gas stream separated from the crude oil stream by a second separator positioned in the GOSP; and
a refrigeration loop comprising:
a mixed refrigerant stream in a liquid state;
a first waste heat recovery heat exchanger configured to transfer heat from the first hydrocarbon gas stream to a first portion of the mixed refrigerant stream to vaporize the first portion of the mixed refrigerant stream;
a second waste heat recovery heat exchanger configured to transfer heat from a first portion of a mixture of the first hydrocarbon gas stream and the second hydrocarbon gas stream to a second portion of the mixed refrigerant stream to vaporize the second portion of the mixed refrigerant stream;
a third waste heat recovery heat exchanger configured to transfer heat from a second portion of the mixture to a third portion of the mixed refrigerant stream to vaporize the third portion of the mixed refrigerant stream;
a turbine-generator configured to receive a combined stream comprising the vaporized first, second, and third portions of the mixed refrigerant stream, the turbine-generator comprising turbine blades coupled to a rotor, the turbine blades configured to rotate in response to flow of the combined stream through the turbine-generator, the rotor configured to rotate with the turbine blades, the turbine-generator configured to generate electrical power in response to rotation of the rotor; and
a condenser configured to cool the combined stream from the turbine-generator to condense the combined stream to reform the mixed refrigerant stream in the liquid state.

8. The system of claim 7, wherein:
the condenser is a first condenser comprising a first side and a second side;
the first side of the first condenser is configured to receive the combined stream from the turbine-generator; and
the system comprises a second condenser configured to receive and cool the combined stream from the first side of the first condenser.

9. The system of claim 8, wherein the second side of the first condenser is configured to receive the combined stream from the second condenser, wherein the first condenser is configured to transfer heat from the combined stream at the first side to the combined stream at the second side.

10. The system of claim 9, comprising a third separator configured to receive and separate phases of the mixture to produce a first aqueous liquid phase and the first portion of the mixture, wherein the first portion of the mixture is in a vapor state prior to entering the second waste heat recovery heat exchanger.

11. The system of claim 10, wherein transferring heat from the first portion of the mixture to the second portion of the mixed refrigerant stream by the second waste heat recovery heat exchanger facilitates at least partial condensation of the first portion of the mixture, wherein the system comprises a fourth separator configured to receive the first portion of the mixture from the second waste heat recovery heat exchanger, wherein the fourth separator is configured to separate phases of the first portion of the mixture to produce a second aqueous liquid phase, a first non-aqueous liquid phase, and the second portion of the mixture, wherein the second portion of the mixture is in a vapor state prior to entering the third waste heat recovery heat exchanger.

12. The system of claim 11, wherein transferring heat from the second portion of the mixture to the third portion of the mixed refrigerant stream by the third waste heat recovery heat exchanger facilitates at least partial condensation of the second portion of the mixture, wherein the system comprises a fifth separator configured to receive the second portion of the mixture from the third waste heat recovery heat exchanger, wherein the fifth separator is configured to separate phases of the second portion of the mixture to produce a third aqueous liquid phase, a second non-aqueous liquid phase, and a fourth portion of the mixture.

13. The system of claim 12, comprising a distillation column configured to receive and fractionate the first non-aqueous liquid phase and the second non-aqueous phase to produce an overhead vapor stream as distillate and a natural gas liquids (NGL) stream as bottoms, wherein a rate at which the NGL stream is produced by the GOSP is increased by at least 5% when compared to a control GOSP that does not capture low grade waste heat from the first hydrocarbon stream, the first portion of the mixture, and the second portion of the mixture via the first waste heat recovery heat exchanger, the second waste heat recovery heat exchanger, and the third waste heat recovery heat exchanger, respectively.

14. A method comprising:
flowing a first hydrocarbon gas stream to a first waste heat recovery heat exchanger, wherein the first hydrocarbon gas stream is separated from a crude oil stream by a first separator positioned in a gas-oil separation plant (GOSP);
transferring, by the first waste heat recovery heat exchanger, heat from the first hydrocarbon gas stream to a first portion of a mixed refrigerant stream to vaporize the first portion of the mixed refrigerant stream;
flowing a first portion of a mixture of the first hydrocarbon gas stream and a second hydrocarbon gas stream to a second waste heat recovery heat exchanger, wherein the second hydrocarbon gas stream is separated from the crude oil stream by a second separator positioned in the GOSP;
transferring, by the second waste heat recovery heat exchanger, heat from the first portion of the mixture to a second portion of the mixed refrigerant stream to vaporize the second portion of the mixed refrigerant stream;
flowing a second portion of the mixture to a third waste heat recovery heat exchanger;
transferring, by the third waste heat recovery heat exchanger, heat from the second portion of the mixture to a third portion of the mixed refrigerant stream to vaporize the third portion of the mixed refrigerant stream;
flowing a combined stream through a turbine-generator, wherein the combined stream comprises the vaporized first, second, and third portions of the mixed refrigerant stream, wherein flowing the combined stream through the turbine-generator causes a rotor of the turbine-generator to rotate;
generating electrical power in response to rotation of the rotor of the turbine-generator; and
condensing the combined stream from the turbine-generator to reform the mixed refrigerant stream in a liquid state.

15. The method of claim 14, wherein condensing the combined stream comprises:
flowing the combined stream through a first side of a first heat exchanger;
flowing the combined stream from the first side of the first heat exchanger through a second heat exchanger; and
flowing the combined stream from the second heat exchanger through a second side of the first heat exchanger, wherein the combined stream flowing through the first side of the first heat exchanger transfers heat to the combined stream flowing through the second side of the first heat exchanger.

16. The method of claim 15, comprising, after transferring heat from the first hydrocarbon gas stream to the first portion of the mixed refrigerant stream, separating phases of the mixture to produce a first aqueous liquid phase and the first portion of the mixture, wherein the first portion of the mixture is in a vapor state prior to transferring heat from the first portion of the mixture to the second portion of the mixed refrigerant stream.

17. The method of claim 16, wherein transferring heat from the first portion of the mixture to the second portion of the mixed refrigerant stream facilitates at least partial condensation of the first portion of the mixture, wherein the method comprises, after transferring heat from the first portion of the mixture to the second portion of the mixed refrigerant stream, separating phases of the first portion of the mixture to produce a second aqueous liquid phase, a first non-aqueous liquid phase, and the second portion of the mixture, wherein the second portion of the mixture is in a vapor state prior to transferring heat from the second portion of the mixture to the third portion of the mixed refrigerant stream.

18. The method of claim 17, wherein transferring heat from the second portion of the mixture to the third portion of the mixed refrigerant stream facilitates at least partial condensation of the second portion of the mixture, wherein the method comprises, after transferring heat from the second portion of the mixture to the third portion of the mixed refrigerant stream, separating phases of the second portion of the mixture to produce a third aqueous liquid phase, a second non-aqueous liquid phase, and a fourth portion of the mixture.

19. The method of claim 18, comprising fractionating the first non-aqueous liquid phase and the second non-aqueous liquid phase to produce an overhead vapor stream as distillate and a natural gas liquids (NGL) stream as bottoms, wherein a rate at which the NGL stream is produced by the GOSP is increased by at least 5% when compared to a control GOSP that does not capture low grade waste heat from the first hydrocarbon stream, the first portion of the mixture, and the second portion of the mixture.
